(19) United States
(12) Patent Application Publication
(10) Pub. No.: US 2010/0213815 A1
(43) Pub. Date: Aug. 26, 2010

(54) HALOGEN LAMP CAPSULE SUPPORT FOR PLASTIC BASE

(75) Inventors: Hossein Aghamehdi, Lititz, PA (US); Yong Shin, York, PA (US); Chrisopher Kenney, Weare, NH (US); Joseph Wegman, Henniker, NH (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 12/390,052

(22) Filed: Feb. 20, 2009

(51) Int. Cl. H01J 5/50

(52) U.S. Cl. 313/318.01

(57) ABSTRACT

An automotive headlamp comprising a light capsule including a seal and a retainer affixed to the seal, the retainer having an upper surface, an extending wall having an outer wall and an inner wall. A plastic base includes a cavity arrayed about an axis and has a circumferential wall about the cavity. A pair of axial slots is formed in the circumferential wall form segments of a circle arching around the axis, the slots being further defined by a pair of oppositely disposed end stops. Metal inserts having base ends sized and shaped to closely fit the axial slots are positioned in the slots, each of the metal inserts having extended resilient fingers each having a retainer engager formed to engage a wall of the retainer to support the retainer; and two retention features formed with each of the base ends, the retention features engaging the circumferential wall.

### TECHNICAL FIELD

This invention relates to automobile headlights and more particularly to those headlights wherein a replaceable lamp unit is used.

### BACKGROUND ART

Automobile headlights wherein a replaceable lamp unit is used as the light source are well known in the art. The instant invention is related to lamps of the variety described above. In particular, the invention defines a replaceable lamp unit, which assures that the electric lamp used therewith in strict alignment as is necessary in automotive headlights.

The replaceable lamp defined herein assures that alignment of the electric lamp used therewith is maintained. That is, alignment of the glass envelope of the lamp relative to the unit's holder is provided such that the filament structure within the envelope (either a single coiled filament or two, spaced coiled filaments) is accurately aligned relative to the optical axis of the reflector when the lamp unit is oriented within the reflectors rear opening. Such alignment is deemed critical to assure optimum headlight output in the direction(s) desired.

As also described herein, a preferred light source (which constitutes an important part of the replaceable lamp unit) is an electric lamp of the tungsten-halogen variety. One example of such a lamp is shown in U.S. Pat. No. 3,829,719, Westlund, Jr., et al., which is assigned to the assignee of the instant invention. In tungsten-halogen lamps, the tungsten, which constitutes the filament material, is evaporated from the filament during lamp operations and combines with the halogen to form a gaseous halide, the halide preventing the tungsten from depositing on the internal wall of the lamp envelope. Upon returning to the filament structure the halide decomposes, resulting in the deposition of tungsten back onto the filament structure and the release of the halogen gas to assure continuation on the cycle. The halogen cycle is well known in the art and lamps using it have been used for some time. In the case of the two-beam (dual filament) lamp, a typical tungsten-halogen lamp provides about 65 watts when operated at high beam and about 55 watts at low beam. As stated, it is critical that the filament structure of the lamp within the automobile headlight be aligned relative to the reflector to provide optimum output of the finished headlight. Such alignment constitutes an important feature of the replaceable lamp unit defined herein.

### DISCLOSURE OF INVENTION

It is, therefore, an object of the invention to obviate the disadvantages of the prior art.

It is another object of the invention to enhance the alignment of automotive headlights.

Yet another object of the invention is the improvement of automotive headlights.

These objects are accomplished, in one aspect of the invention, by the provision of an automotive headlight comprising a light source capsule including a seal area; a cup-shaped retainer affixed to the seal area, the cup-shaped retainer having an upper surface, an outer wall surface and an inner wall surface; a plastic base including a cavity arrayed about and axis and a circumferential wall about the cavity; a pair of oppositely disposed, axial slots formed in the circumferential wall, the slots forming segments of a circle arching around the axis, the slots being further defined by a pair of oppositely disposed end stops; a pair of metal inserts having base ends sized and shaped to closely fit the axial slots positioned in the slots, each of the metal inserts having two resilient fingers each having a retainer engager formed to engage the inner wall surface of the retainer and engaging and supporting the retainer; and retention features formed with the base ends, the retention features engaging the circumferential wall.

The use of the retainer and resilient fingers on the metal inserts allows for accurate positioning of the lamp relative to the plastic holder. Further, it removes any support function from the lamp lead-ins, allowing greater flexibility of the lead-in attachment to the necessary socket prongs. Positioning the retainer engagers on the inside of the retainer smoothes the entire design and minimizes the risk of accidentally striking one of the resilient fingers (during insertion into a reflector) and disturbing the lamp alignment.

### BRIEF DESCRIPTION OF THE DRAWINGS

FIG. 1 is an elevational view of an embodiment of the invention;

FIG. 2 is a sectional, plan view taken along the line 2-2 of FIG. 1;

FIG. 3 is an enlarged, perspective view of an insert according to an embodiment of the invention; and

FIG. 4 is a sectional view taken along the line 4-4 of FIG. 2.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

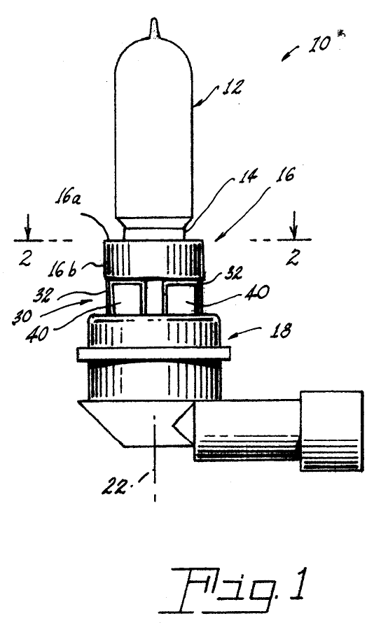

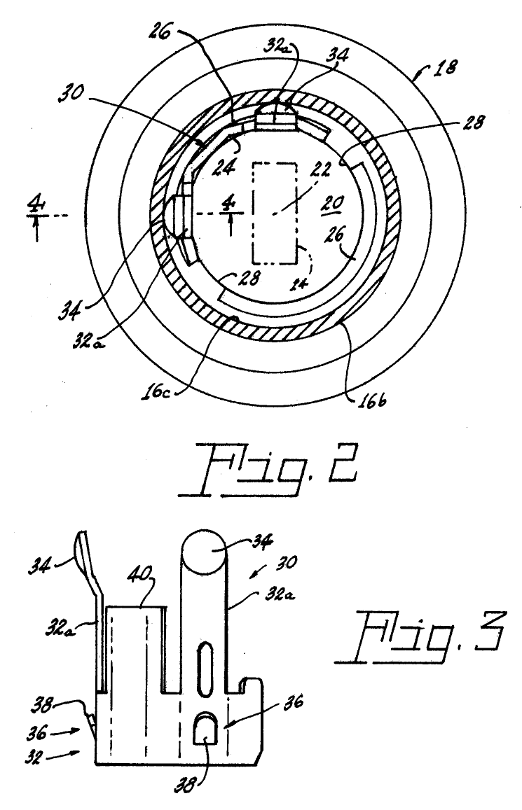

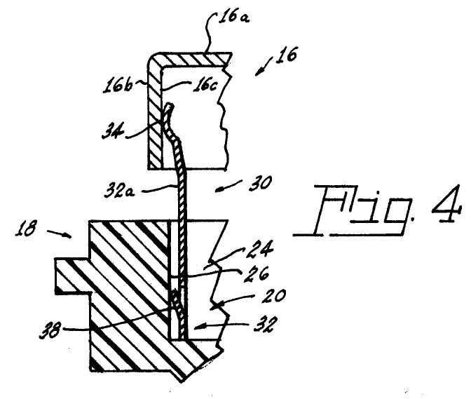

Referring now to the drawings with greater particularly, there is shown in FIG. 1 an automotive headlamp 10 having a light source capsule 12 that can be a tungsten-halogen and that includes a seal area 14 that contains lead-ins 14a and 14b. A cup-shaped retainer 16 is provided and has a top surface 16a, and outer wall surface 16b and an inner wall surface 16c. An opening 16d (shown in phantom lines in FIG. 2) is provided for receiving the seal area 14.

A plastic base 18 includes a cavity 20 arrayed about an axis 22 and has a circumferential wall 24 thereabout. Two axial slots 26 are formed in the circumferential wall 24, these slots 26 forming segments of a circle arching around the axis 22. The slots 26 are further defined by two, angularly located end stops 28. The slots 26 and stops 28 are best seen in FIG. 2.

A pair of metal inserts 30 (only one of which is shown in FIG. 2 for clarity purposes) preferably formed from a stamped metal, such as stainless steel or similar material having the same thermal expansion properties as the glass capsule retainer 16, and having base ends 32 sized and shaped to closely fit the axial slots are frictionally positioned in the slots 26, each of the metal inserts 30 having two extended resilient fingers 32a, each of which is provided with a retainer engager 34 for engaging and supporting the retainer 16. Retention features 36, in the form of prongs 38, are struck from the base end 32, and engage the circumferential wall 24, drastically increasing the force necessary to remove the inserts. In the preferred embodiment, at least one insert 30 is flexible, and preferably only slightly flexible so as to impart a relatively high spring constant. The insert are preferably formed with slightly differing circumferential curvatures so the insert must be circumferentially flexed to slide axially into the slot. The preferred insert 30, when in position in the slot, is then under tension or even high tension with respect to the internal walls forming the slot. This tension between the insert and slot helps accurately position and hold the insert with respect to the slot and therefore with respect to the base.

If desired, the inserts 30 can be provided with up-standing shields arrayed on either side of the fingers 32a for the purpose, among others, of blocking light that may emerge from the capsule press area; aiding in the alignment of the metal insert 30 during assembly; and further increase in the force necessary for pull-out during assembly.

During the assembly of the light source capsule 12 to the base 18, the retainer 16 is positioned with the resilient fingers 32a (and their corresponding retainer 34 contacting the inner wall 16c) and the lead-ins 14a and 14b connected to the necessary socket prongs (not shown). At this point the light source capsule 12 and its retainer can be moved about the axis 22 to achieve the proper alignment, at which time the retainer engagers are welded to the retainer inner wall 16c, preferably by laser welding, although other forms of attachment can be used. Positional movement is easily achieved by virtue of the shape of the retainer engagers, which shape is in the form of a spherical section. Thus, contact with the inner wall 16c is by a single point on each retainer engager, which greatly reduces the energy necessary to move the lamp and achieve the necessary alignment.

Thus, there is provided a ruggedized, alignment-correct automotive headlamp that is economical to produce. Positional movement of the retainer about the retainer engagers is easily accomplished, and the positioning of the retainer engagers on the inner wall of the retainer prevents subsequent damage when the lamp is inserted into a reflector.

While there have been shown and described what are at present considered to be the preferred embodiments of the invention, it is apparent to those skilled in the art that various changes and modifications can be made herein without departing from the scope of the invention as defined by the appended claims.

What is claimed is:

1. An automotive headlamp comprising:
a light source capsule including a seal area;
a retainer affixed to said seal area, said retainer having an upper surface and a wall extending therefrom, said wall having an outer wall surface and inner wall surface;
a plastic base including a cavity arrayed about an axis and a circumferential wall about said cavity;
a pair of oppositely disposed, axial slots formed in said circumferential wall, said slots forming segments of a circle arching around said axis, said slots being further defined by a pair of oppositely disposed, end stops;
a pair of metal inserts having base ends sized and shaped to closely fit said axial slots positioned in said slots, each of said metal inserts having two extended resilient fingers each having a retainer engager formed to engage said inner wall surface of said retainer and engaging and supporting said retainer; and
retention feature formed with each of said base ends, said retention features engaging said circumferential wall.

2. The automotive headlamp of claim 1 wherein said retention feature comprises two prongs struck from said base end.

3. The automotive headlamp of claim 1 wherein said inserts are formed from stamped metal.

4. The automotive headlamp of claim 1 wherein said inserts are arrayed in a circle.

5. The automotive headlamp of claim 1 wherein each of said inserts is provided with up-standing shields arrayed on either side of said resilient fingers.

6. The automotive headlamp of claim 1 wherein the retainer is cup shaped.

7. The automotive headlamp of claim 1 wherein at least one insert is flexible, and when in position in the corresponding slot is under tension with respect to walls forming the slot.
